(19) United States
(12) Patent Application Publication
(10) Pub. No.: US 2018/0189603 A1
(43) Pub. Date: Jul. 5, 2018

(54) USER FEED WITH PROFESSIONAL AND NONPROFESSIONAL CONTENT

(71) Applicant: Microswoft Technology Licenswing, LLC, Redmond, WA (US)

(72) Inventors: Liang Zhang, Fremont, CA (US); Lin Zhu, Beijing (CN); Di Wang, Beijing (CN); Sheng Zhao, Beijing (CN); Yang Liu, Beijing (CN); Shu Chen, Beijing (CN)

(21) Appl. No.: 15/125,801

(22) PCT Filed: Jul. 14, 2016
(86) PCT No.: PCT/CN2016/090063

§ 371 Date: Sep. 13, 2016

(51) Int. Cl. G06K 9/62; G06F 17/27; G06F 15/18; G06Q 50/00

(52) U.S. Cl. CPC G06K 9/6223; G06Q 50/01; G06F 15/18; G06F 17/2785

(57) ABSTRACT

Methods, systems, and computer programs are presented for optimizing the content of a user feed that includes professional and nonprofessional posts. One method includes an operation for training a machine-learning classifier to classify posts of a social website as professional or nonprofessional posts based on a plurality of features that include a cluster assigned to each post. Posts are identified for placement in a user feed of the social website, each post being associated with a score, and each post is assigned to one of the clusters based on the semantic meaning of the words in the post. The method further includes operations for invoking the machine-learning classifier to classify each post as a professional or a nonprofessional post, and for increasing the scores of the posts classified as professional posts. The posts are ranked for presentation in the user feed based on the score of each post.

### TECHNICAL FIELD

The subject matter disclosed herein generally relates to methods, systems, and programs for ranking content in a social network, and more particularly, methods, systems, and computer programs for selecting content for posting on a user feed of a social network.

### BACKGROUND

Social networks often provide a large amount of content for presentation to a user, in what is commonly referred to as the user feed. The interest of the user in the user feed depends mostly on the quality of the content: if the content is not interesting, the user will abandon the social network, but if the content is interesting, the user will continue accessing the user feed.

Finding content of interest to the user is a challenging proposition because the social network has to understand the content of the posts in the user feed in order to attribute an expected level of interest to the user. The problem is further compounded when the user feed includes professional content (e.g., content related to the profession of the user) and nonprofessional content (e.g., content related to the friends of the user in the social network).

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIGS. 2A and 2B are screenshots of a user interface that includes a user feed on a social website, according to some example embodiments.

FIG. 3 is a flowchart of a method, according to some example embodiments, for selecting content for the user feed.

FIG. 4 is a diagram illustrating a method for training a classifier, according to some example embodiments.

FIG. 5 is a diagram illustrating the assignment of a post to a cluster, according to one example embodiment.

FIG. 6 is a diagram illustrating a method, according to some example embodiments, for ranking nonprofessional content.

FIG. 7 is a diagram illustrating a method, according to some example embodiments, for creating the user feed.

FIG. 8 illustrates a social networking server that provides access to user feeds, according to one example embodiment.

FIG. 9 is a flowchart of a method, according to some example embodiments, for optimizing the content of a user feed that includes professional and nonprofessional posts.

FIG. 10 is a block diagram illustrating an example of a software architecture that may be installed on a machine, according to some example embodiments.

FIG. 11 illustrates a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are presented for optimizing the content of a user feed that includes professional and nonprofessional posts. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some example embodiments, a user feed in a social website includes professional content, related to the professional activities of the user, mixed with nonprofessional content related to the social activity of the user. The content is provided by other users of the social network, and the system determines if each post is considered professional or nonprofessional content by utilizing machine-learning techniques to train a classifier to automatically determine the type of the post.

The machine-learning classifier utilizes one or more features to make a determination as to whether the post is considered professional or non-professional. Features are aspects of the post or posting member that may include information useful in determining whether a post is considered professional or non-professional. One of the features considered by the machine-learning classifier is the text of the post. The text is analyzed and the words in the post are assigned to one of a plurality of clusters based on the semantic meaning of each word. Further, the post is assigned to one of the clusters based on the clusterization of the words. The clusters of the words and the post are then used as features for the machine-learning classifier, also referred to as the machine-learning tool or the P/NP tool.

After the machine-learning classifier determines the type of the post, the professional and nonprofessional posts are mixed into the user feed, based on a score assigned to each post. In one example embodiment, the scores of professional posts are boosted (e.g., increased) to favor the professional posts over the nonprofessional posts.

In one general aspect, a method includes an operation for training a machine-learning classifier to classify posts of a social website as professional or nonprofessional posts based on a plurality of features that include a cluster assigned to each post. Posts are identified for placement in a user feed of the social website, each post being associated with a score, and each post is assigned to one of the clusters based on the semantic meaning of the words in the post. The method further includes operations for invoking the machine-learning classifier to classify each post as a professional or nonprofessional post, and for increasing the scores of the posts classified as professional posts. The posts are ranked for presentation in the user feed based on the score of each post. This increases a positioning of professional posts relative to non-professional posts.

One general aspect includes a system including a memory including instructions and one or more computer processors. The instructions, when executed by the one or more computer processors, cause the one or more computer processors to perform operations including training a machine-learning classifier to classify posts of a social website as professional posts or nonprofessional posts based on a plurality of features, the plurality of features including a cluster from a plurality of clusters assigned to each post. Posts are identified for placement in a user feed of the social website, each post being associated with a score, and each post is assigned to one of the clusters based on the semantic meaning of the words in the post. The operations further include invoking the machine-learning classifier to classify each post as a professional post or nonprofessional post, and an operation for increasing the scores of the posts classified as professional posts. The posts are ranked for presentation in the user feed based on the score of each post.

One general aspect includes a non-transitory machine-readable storage medium including instructions that, when executed by a machine, cause the machine to perform operations including training a machine-learning classifier to classify posts of a social website as professional posts or nonprofessional posts based on a plurality of features, the plurality of features including a cluster from a plurality of clusters assigned to each post. Posts are identified for placement in a user feed of the social website, each post being associated with a score, and each post is assigned to one of the clusters based on the semantic meaning of the words in the post. The operations further include invoking the machine-learning classifier to classify each post as a professional post or nonprofessional post, and an operation for increasing the scores of the posts classified as professional posts. The posts are ranked for presentation in the user feed based on the score of each post.

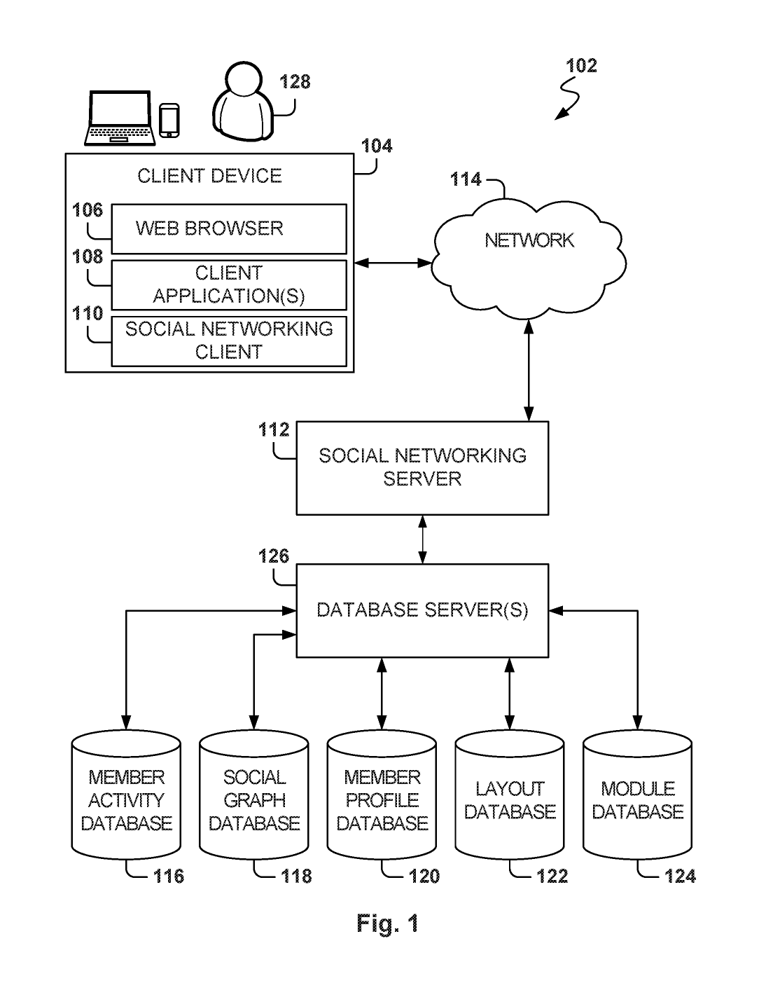

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106 (e.g., the Internet Explorer® browser developed by Microsoft® Corporation), client application(s) 108, and a social networking client 110 executing on the client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, an ultra book, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access to member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a layout database 122, and a module database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history, professional industry, skills, professional organizations, and so on. This information is stored, for example, in the member profile database 120. Similarly, when a representative of an organization initially registers the organization with the social networking service provided by the social networking server 112, the representative may be prompted to provide certain information about the organization. This information may be stored, for example, in the member profile database 120. In some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The layout database 122 stores one or more layout configuration files for defining the layout of a corresponding webpage. In one embodiment, a layout configuration file defines the portions and/or sections of a webpage according to the type and/or substance of content that is to appear in each defined portion and/or section of the webpage. In this manner, one or more webpages provided by the social networking server 112 may each be associated with a corresponding layout configuration file. Alternatively and/or additionally, a layout configuration file corresponds to more than one webpage.

The module database 124 provides access to one or more modules which may be retrieved by the social networking server 112 and communicated to the client device 104. The modules stored within the module database 124 provide various functionalities and features for engaging with the social networking service provided by the social networking server 112. In one embodiment, the modules stored within the module database 124 are designed to provide a given feature or functionality. For example, the module database 124 may include a module that provides updates about a member's connections, a module that facilitates the uploading and/or editing of a member's profile selected from the member profile database 120, a module that retrieves news or other items of interest for a member's profile, a module that facilitates searching for content provided by the social networking server 112, and other such modules. In summary, the modules stored in the module database 124 may provide one or more functionalities that enhance a member's experience with the social networking service.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (“SOA”), one or more services provided via a REST-Oriented Architecture (“ROA”), or combinations thereof. In an alternative embodiment, the social networking server 112 communicates with the databases 116-124 and includes a database client, engine, and/or module, for providing data to, modifying data stored within, and/or retrieving data from the one or more databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

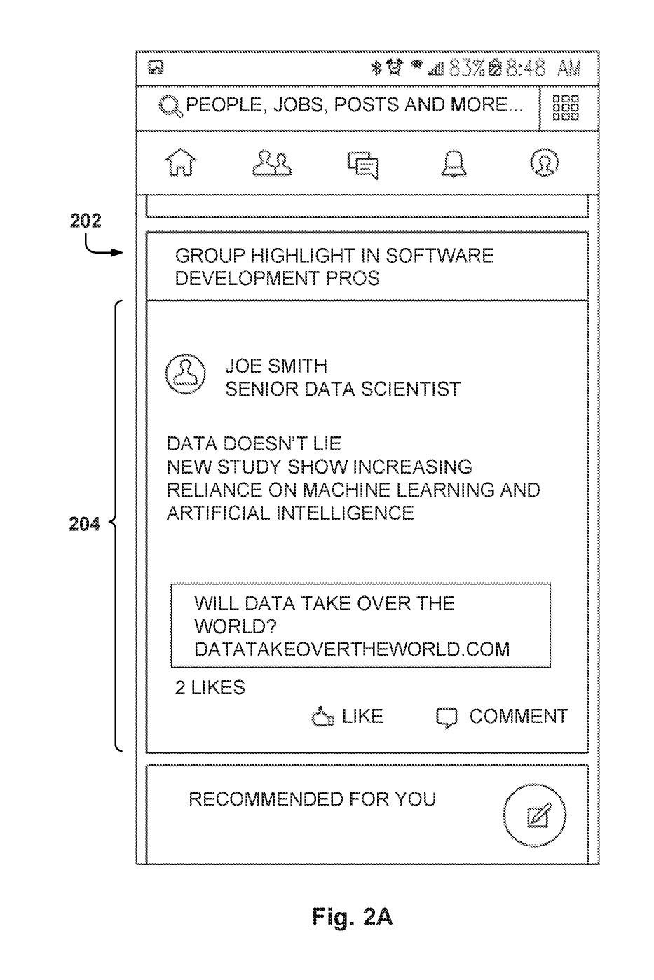

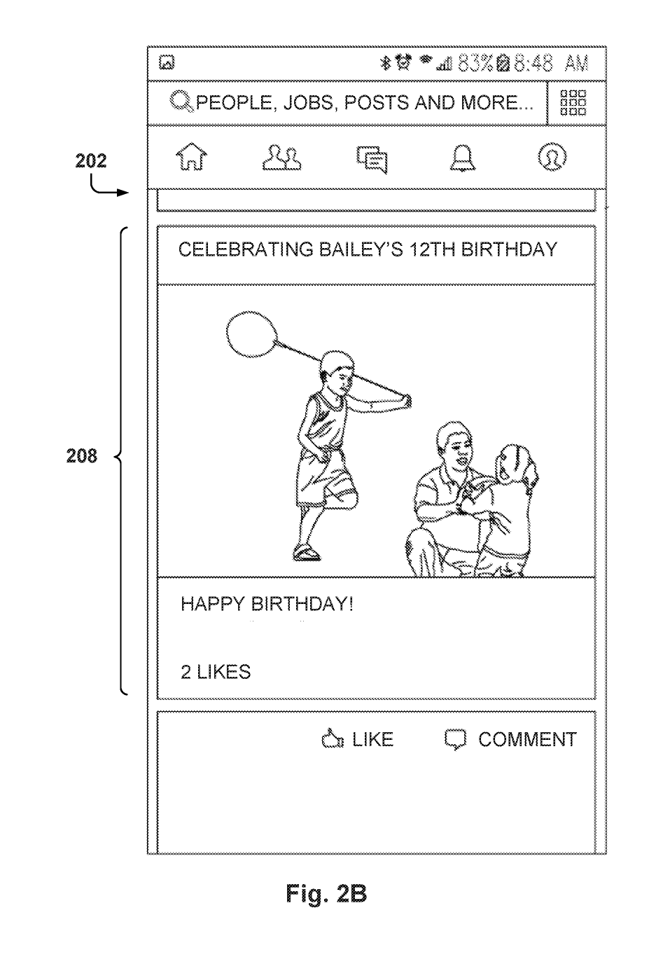

FIGS. 2A and 2B are screenshots of a user interface that includes a user feed 202 on a social website, according to some example embodiments. In one example embodiment, the user feed 202 includes one or more user posts 204, 208. As the user scrolls down the user feed 202, more posts are presented to the user. In some example embodiments, the posts are prioritized to present posts in an estimated order of interest to the user.

In one example embodiment, the posts are classified into one of a professional post (e.g., post 204) or a nonprofessional post (e.g., 208). The professional posts are associated with a professional activity of the user, while the nonprofessional posts are related to the social activity of the user on the social network. A professional activity relates to an action of the user that is associated with the user's job. If the user works for a for-profit organization, the activity relates to a business purpose or a commercial purpose. If the user's job is a Government job, the professional activity may include government activities related to the user's job. If the user works for a non-profit organization, the professional activity may include actions related to the non-profit organization. The criteria to prioritize professional and nonprofessional posts are different because of the different nature of the posts. For example, a nonprofessional post may be ranked high if the poster has a close relationship to the user, but a professional post may be ranked high even if the poster does not have a close relationship to the user, for example, if the poster is a recognized authority in the profession of the user.

In some example embodiments of the user feed 202, the social network determines how to sort the professional and nonprofessional posts according to multiple criteria. For example, some users may be more interested in professional content while other uses may be more interested in nonprofessional content. Further, the social network decides how to sort professional posts by estimating which ones will be of higher interest to the user.

When a user first joins the social network, the user may not have many user connections on the social network. Therefore, it is important to provide professional content that is of high interest to the user, in order to increase the participation of the user in the social network, so the user can continue adding new connections and provide content for other users.

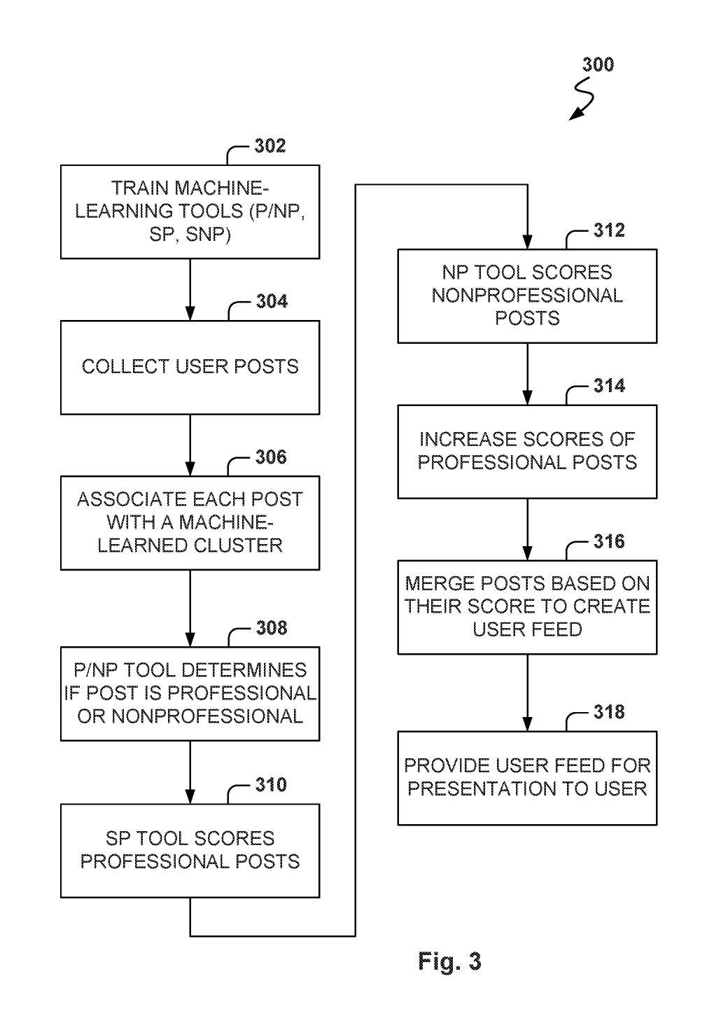

FIG. 3 is a flowchart of a method 300, according to some example embodiments, for selecting content for the user feed. While the various operations in this flowchart are presented and described sequentially, one of ordinary skill will appreciate that some or all of the operations may be executed in a different order, be combined or omitted, or be executed in parallel.

The method 300 describes the operations performed to create a user feed. The operations are described at a high level, and more details for each of the operations are presented in the descriptions of the figures following FIG. 3.

Machine learning is a field of study that gives computers the ability to learn without being explicitly programmed. Machine learning explores the study and construction of algorithms, also referred to herein as tools, that can learn from existing data and make predictions about new data. Such machine-learning tools operate by building a model from example inputs in order to make data-driven predictions or decisions expressed as outputs. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), and Support Vector Machines (SVM) tools may be used for classifying or scoring posts.

In general, there are two types of problems in machine learning: classification problems and regression problems. Classification problems aim at classifying items into one of several categories. For example, is this object an apple or an orange? Regression algorithms aim at quantifying some item, for example by providing a value that is a real number. In our case, example embodiments classify posts to determine if the posts are professional or nonprofessional. In other example embodiments, machine learning is also utilized to provide a score (e.g., a number from 1 to 100) for the quality of a post.

At operation 302, one or more machine-learning tools are trained. In example embodiments, several machine-learning tools are utilized to create the user feed: a score-professional (SP) tool that provides a score for a professional post, a score-nonprofessional (SNP) tool that provides a score for a nonprofessional post, and a professional/nonprofessional (P/NP) tool that determines if a post is a professional post or a nonprofessional post.

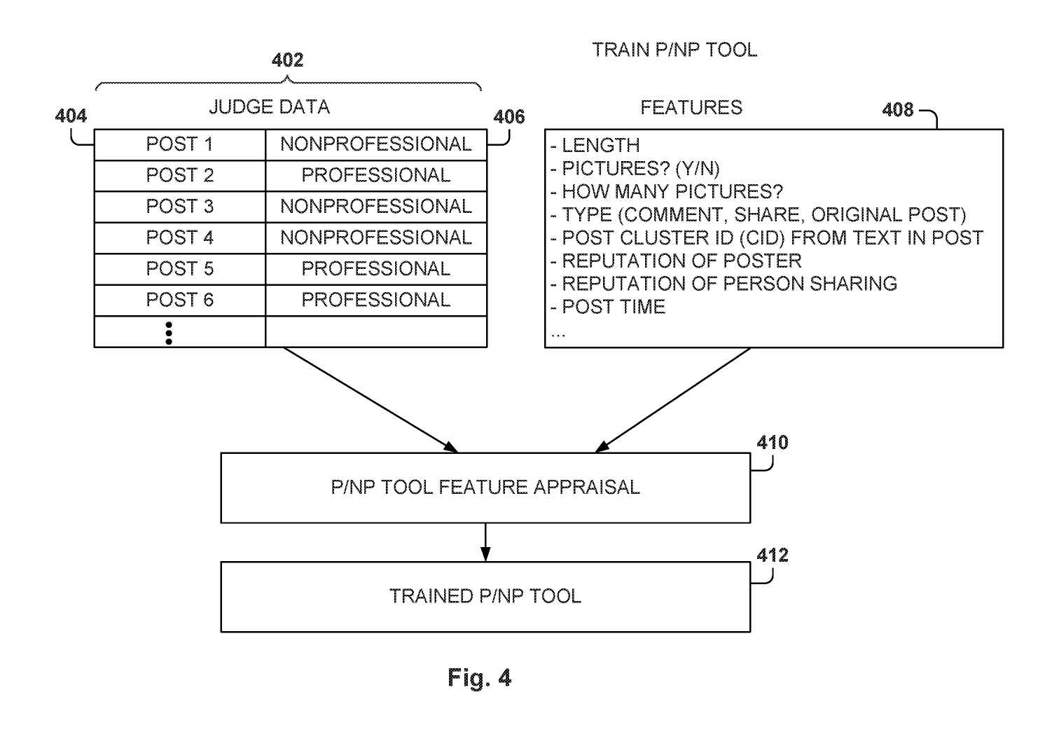

In some example embodiments, the machine-learning tools are trained utilizing existing data. For example, data may be entered by human judges who classify posts as professional or nonprofessional posts, but other types of data are also possible. More details are provided below with reference to FIG. 4 regarding the training of the P/NP tool.

After the tools have been trained, at operation 304, the user posts are collected. The user posts may be created in many ways, such as by users of the social network, or the posts may refer to web pages with information available on the Internet. or the posts may be created by the social network provider, or the posts may be created by advertisers, etc.

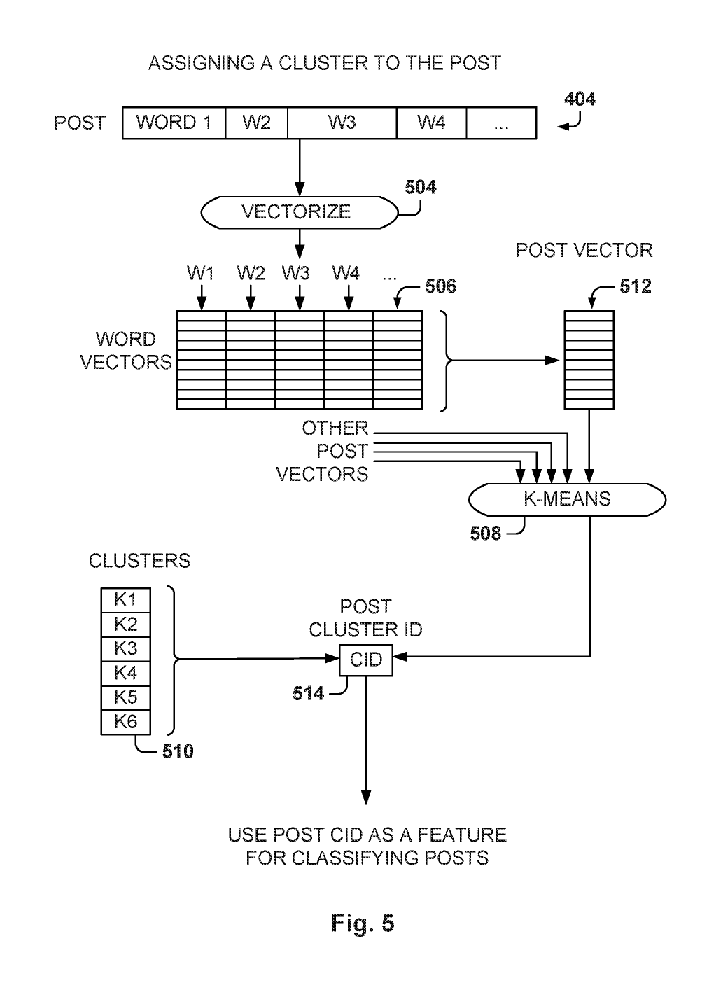

From operation 304, the method flows to operation 306, where each post is associated with (e.g., assigned to) a machine-learned cluster from a plurality of clusters. The clusters are based on the semantic meaning of the words in the post. More details are provided below on the assignment of posts to clusters in FIG. 5.

At operation 308, the P/NP tool determines if each of the posts is a professional post or a nonprofessional post. Further, at operation 310, the SP tool provides a score for each of the professional posts. In some example embodiments, the SP tool uses a relevance model to provide scores for the post. In other example embodiments, the professional posts are first presented at random in some user feeds, and then a click-through rate (CTR) is measured. The CTR becomes the score for the post, although other factors may be utilized to calculate the score, such as the author of the post, the time when the post was created, etc.

In some example embodiments, the ranking of the posts is not done according to post time, because the social network emphasizes the quality of the content instead of the time when the content was created. For this reason, in some example embodiments, the post-creation time is not presented, because users may get confused. If the post-creation time is presented, the user may assume that the user feed has a chronological order, but since posts are classified according to their score, the posts may not follow the order of the post-creation time, and the user will be confused.

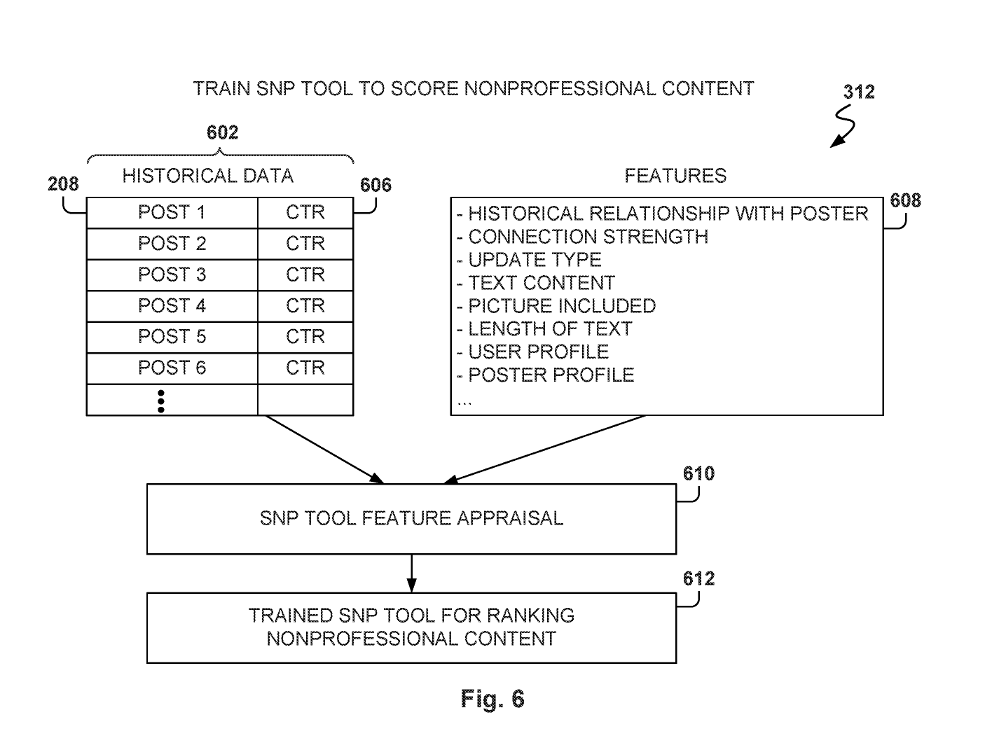

At operation 312, the SNP tool provides a score for the nonprofessional posts. More details regarding operation 312 are provided below with reference to FIG. 6.

In some example embodiments, the scores for the professional or nonprofessional posts are based on the CTR. However, if the posts were to be ranked by the CTR alone, then nonprofessional posts would usually have higher scores. To avoid emphasizing the nonprofessional content over professional content, some example embodiments increase the scores for the professional posts, in order to boost presentation of professional content in the social network.

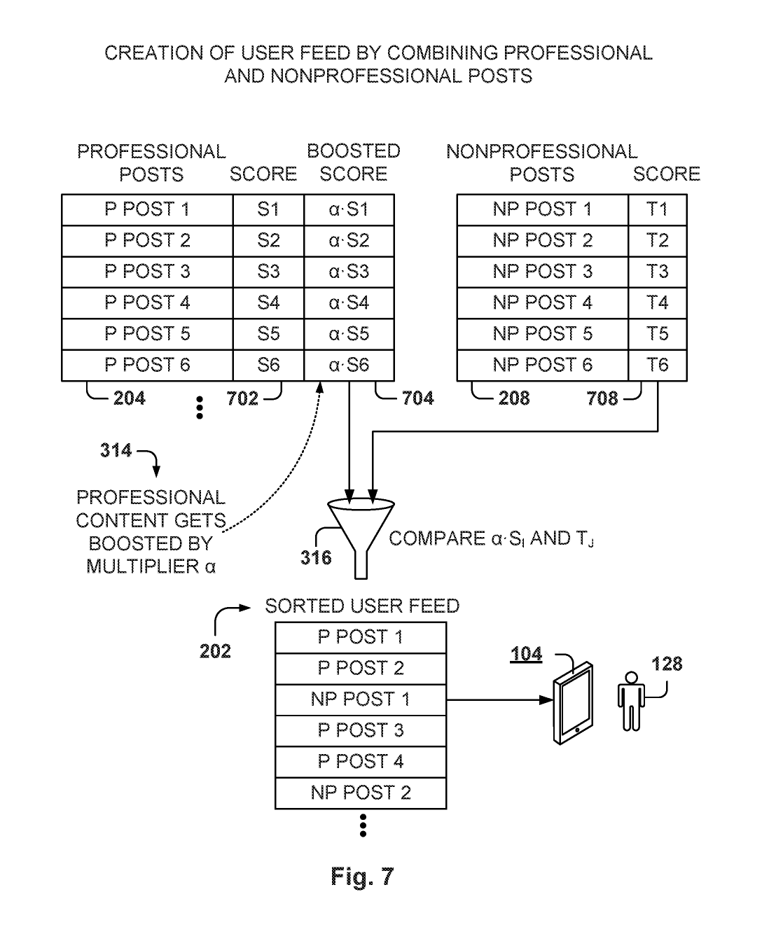

From operation 312, the method flows to operation 314, where the scores of the professional posts are increased. At operation 316, the professional and nonprofessional posts are merged based on their respective scores in order to create the user feed. At operation 318, the user feed is provided for presentation to the user. More details regarding operations 314, 316, and 318 are provided below with reference to FIG. 7.

FIG. 4 is a diagram illustrating the method for training the P/NP tool, according to some example embodiments. The P/NP tool gives an answer to the question, is this post a professional post or a nonprofessional post?

Initially, judge data 402 is collected. As used herein, a judge is a person, also referred to as an editor, who reads a post and classifies the post according to one of the available categories. In one example embodiment, the judges examine each post 404 and assign a category 406 to the post as either professional or nonprofessional. In another example embodiment, category data is received from users of the social network.

In addition, features 408 are identified for training the machine-learning P/NP tool. The identified features are then used by the machine-learning P/NP tool to classify the posts 404. In one example embodiment, the features include one or more of the following:
a length of the post (e.g., expressed as the number of characters or the number of words);
a flag indicating if the post includes pictures or not;
a number of pictures in the post;
a type of the post. In one example embodiment, the post could be a comment on another user's post, or a share of another user's post, or an original post created by the user;
A machine-learned post cluster ID (CID) that is trained from the text in the post and the text in shared content (for example, if a user shares an article or another user's post, the text in the shared content). More details, on how the CID is used as a feature for the P/NP tool, are provided below with reference to FIG. 5.
a reputation score of the poster who originally created the post;
a reputation score of the poster who shared the post; or
a time when the post was posted.

It is to be noted that one of the most challenging parts of evaluating features for classification is the evaluation of the content (e.g., text) in the post. Simply using words as a feature may be less effective because many words have synonyms, and some words have multiple semantic meanings. This is why, in some example embodiments, the semantic meaning of each word is utilized as the feature. More details are provided below with reference to FIG. 5 on how to identify the semantic meaning of each word, and estimate the semantic meaning of the post.

At operation 410, the machine-learning P/NP tool is trained by appraising the value of each feature to the classification process. As a result of the training, a trained P/NP tool 412 is ready to be used for classifying new posts.

It is noted that the embodiments illustrated in FIG. 4 are exemplary. Other embodiments may utilize different features, additional features, fewer features, etc. The embodiments illustrated in FIG. 4 should therefore not be interpreted to be exclusive or limiting, but rather exemplary or illustrative.

FIG. 5 is a diagram illustrating the assignment of the post to a cluster, according to one example embodiment. Using the text in the post as a feature for classifying professional or nonprofessional content is challenging. For example, a linear regression (LR) algorithm may be used for other features, but LR is harder for text since words may mean different things according to the context in which the words are used.

In order to include a feature correlated to the semantic meaning of the post, the words of the post are classified according to their semantic meaning, and then their semantic meaning is used to classify the post into one of a plurality of clusters.

First, the post 404 is parsed to identify the words in the post 404. In the English language, this is a straightforward proposition, but parsing is more complex in other languages like Chinese, where there are no spaces between words acting as delimiters.

At operation 504, each word is vectorized, which means that a high-dimensional vector 506 is assigned to each word, where each vector 506 is correlated with a semantic meaning of the word. In one example embodiment, the tool Word2vec is utilized for the vectorization operation 504, but other tools such as Latent Dirichlet Allocation (LDA) may also be utilized.

Word2vec is a group of related models that are used to produce word embeddings. These models are shallow, two-layer neural networks that are trained to reconstruct linguistic contexts of words. Word2vec takes as input a large corpus of text and produces a high-dimensional space (typically between a hundred and several hundred dimensions). Each unique word in the corpus is assigned a corresponding vector 506 in the space. The vectors 506 are positioned in the vector space such that words that share common contexts in the corpus are located in close proximity to one another in the space. In one example embodiment, each element of the vector 506 is a real number.

For example, Word2vec may be utilized to identify the similarity between two words. In one example, a large number of titles were used as input, and a list was created of words having a similar meaning to the word “software.” The list included the misspelling “sofware” with an indicated probability of being related to “software” of 0.8110, and the word “android” with a probability of 0.6615.

After the word vectors 506 are created, a post vector 512 is created based on the word vectors 506. In one example embodiment, the post vector 512 is the average of the word vectors 506, but other equations are also possible. The post vector 512 is used as an input to a tool that classifies the posts vectors into corresponding clusters, according to the proximity between the post vectors. In one example embodiment, K-means clustering 508 is used to assign the post to one of a plurality of clusters.

K-means clustering is a method of vector quantization, originally used in signal processing, that is popular for cluster analysis in data mining. K-means clustering aims to partition n observations into k clusters, where each observation belongs to the cluster with the nearest mean, serving as a prototype of the cluster. This results in a partitioning of the data space into Voronoi cells.

In some example embodiments, the number of clusters is between 5 and 10, but other embodiments may utilize between 10 and 100 clusters or more. In one example embodiment of an implementation in the Chinese language, some of the clusters identified included a life-style cluster, a cluster for sharing professional content, a cluster for advertisements and job postings, and a cluster for posts written in English.

The result of the K-means clustering 508 is the post cluster ID (CID) 514. In the exemplary embodiment of FIG. 5, the use of six clusters K1-K6 is illustrated. Therefore, the post CID 514 is one of the six clusters K1-K6.

In one example embodiment, the post CID 514 is used as a feature for the P/NP tool. Since the vectorization of the words is performed based on the semantic meaning of the words and the post vector 512 is based on the semantic meaning of the words in the post, the cluster or topic for the post is likewise associated with the semantic meaning of the post. This semantic meaning of the post enhances the classification algorithm of the P/NP tool.

FIG. 6 is a diagram illustrating the operation 312, according to some example embodiments, for ranking (e.g., scoring) nonprofessional content. The training of the SNP tool is similar to the training of the P/NP tool illustrated in FIG. 4. The training data includes historical data 602, including a plurality of nonprofessional posts 208 and the corresponding CTRs 606. The CTR 606 is measured based on the number of clicks divided by the number of views of the post, but other equations for the calculation of CTRs may also be utilized.

In one example embodiment, the features 608 identified for the SNP tool include:
a historical relationship between the viewer and the poster who created the post;
a connection strength between the viewer and the poster, where the connection strength is based on the level of activity in the social network between the poster and the viewer;
a type of the update (e.g., comment, share, or original post);
the text in the post. In one example embodiment, the cluster information for the post is used, as illustrated in FIG. 5;
a flag indicating if the post includes a picture or not;
a length of the text in the post (e.g., measured as number of characters or number of words);
a profile of the viewer;
a profile of the poster who created the post; and
a profile of the user who created the original post when the post is shared by another user;

At operation 610, the SNP tool is executed to appraise the features based on the historical data 602. At operation 612, the SNP tool is trained for ranking the nonprofessional content. In one example embodiment, the output of the SNP tool is an NP score value (e.g., a real number) associated with the relevance of the post to the viewer; the higher the NP score, the more relevant the post is to the viewer.

FIG. 7 is a diagram illustrating operations 314 and 316, according to some example embodiments, for creating the user feed 202. After classifying the posts 204, 208 for the user feed 202 as professional or nonprofessional posts, and after obtaining a score (e.g., scores 702 and 708) for each post, the next operation is to create the user feed 202 by combining the professional and nonprofessional posts.

In one example embodiment, the social network is configured to boost the professional content on the user feed 202 over the nonprofessional content. In one example embodiment, boosting the professional content is achieved by increasing the scores 702 of the professional posts 204.

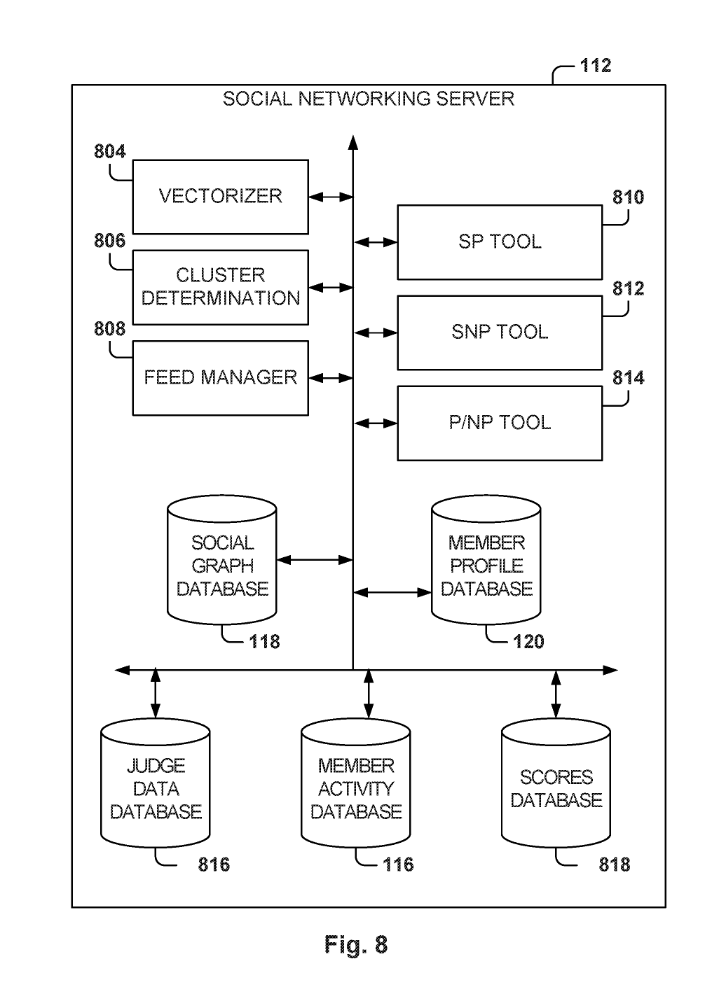

To form the user feed 202, a feed manager 808 (see FIG. 8) combines professional posts 204 and nonprofessional posts 208 to create the sorted user feed 202, which is provided for presentation to the user 128 on the client device 104.

Each professional post 204 is associated with a score S 702. In one example embodiment, the score 702 is based on the CTR for professional posts. In one example embodiment, the professional posts 204 are sorted according to their score, with the highest score being at the top of the list.

In order to boost the presence of professional posts, at operation 314, the professional post score 702 is boosted, e.g., increased, and when professional and nonprofessional posts are sorted together, the professional posts 204 are given more weight because of the boost.

In one example embodiment, the professional post scores 702 are boosted by multiplying the professional post scores 702 by a constant α that is greater than one to obtain boosted post scores 704. In some example embodiments, a has a value in the range between 1.1 and 2.0, but in other example embodiments, a may be in the range between 1.1 and 20 or more.

In other example embodiments, other equations may be used to boost the score, such as utilizing a quadratic equation, or a polynomial equation, or a step function, etc.

At operation 316, the feed manager 808 compares the boosted scores S 704 of the professional posts with the scores T 708 of the nonprofessional posts and creates a sorted user feed 202 of professional and nonprofessional posts in decreasing order of scores.

In the exemplary embodiment of FIG. 7, the sorted user feed 202 begins with the professional post with the highest score, followed by the professional post with the second highest score, followed by the nonprofessional post with the highest score, etc.

FIG. 8 illustrates the social networking server 112 that provides access to user feeds, according to one example embodiment. In one example embodiment, the social networking server 112 includes a plurality of tools for managing the user feed and a plurality of databases. The plurality of tools for managing the user feed include a vectorizer 804, a cluster determination module 806, a feed manager 808, the SP tool 810, the SNP tool 812, and the P/NP tool 814.

The vectorizer 804 takes a post as an input, parses the words of the post, and creates a vector for each word of the post. In one embodiment, the vectorizer utilizes the Word2vec tool, as described above with reference to FIG. 5.

The cluster determination module 806 takes the word vectors as inputs, calculates the post vectors based on the word vectors of the words in each post, and assigns each post to a cluster from a plurality of clusters. In one embodiment, the cluster determination module 806 utilizes K-means clustering, as described above with reference to FIG. 5.

The feed manager 808 creates the user feed 202 for presentation on the user interface of the client device 104. In one example embodiment, the feed manager 808 combines professional posts and nonprofessional posts as described above with reference to FIG. 7.

The SP tool 810 determines the score of professional posts utilizing a machine-learning algorithm based on a plurality of features, such as the click-through rage and the semantic meaning of words in the post, but other metrics can be utilized, such as the amount of time the post is on the display of a user, or the number of times that a user requests to take the post off of the user feed.

The SNP tool 812 determines the score of nonprofessional posts utilizing a machine-learning algorithm based on a plurality of features, such as the features described above with reference to FIG. 6.

The P/NP tool 814 classifies posts as professional posts or nonprofessional posts utilizing a machine-learning algorithm based on a plurality of features, such as the features described above with reference to FIG. 4.

It is to be noted that the embodiments illustrated in FIG. 8 are exemplary. Other embodiments may utilize different modules or machine-learning algorithms, combine the functionality of two modules into one module, distribute the functionality of one module across a plurality of servers, etc. The embodiments illustrated in FIG. 8 should therefore not be interpreted to be exclusive or limiting, but rather exemplary or illustrative.

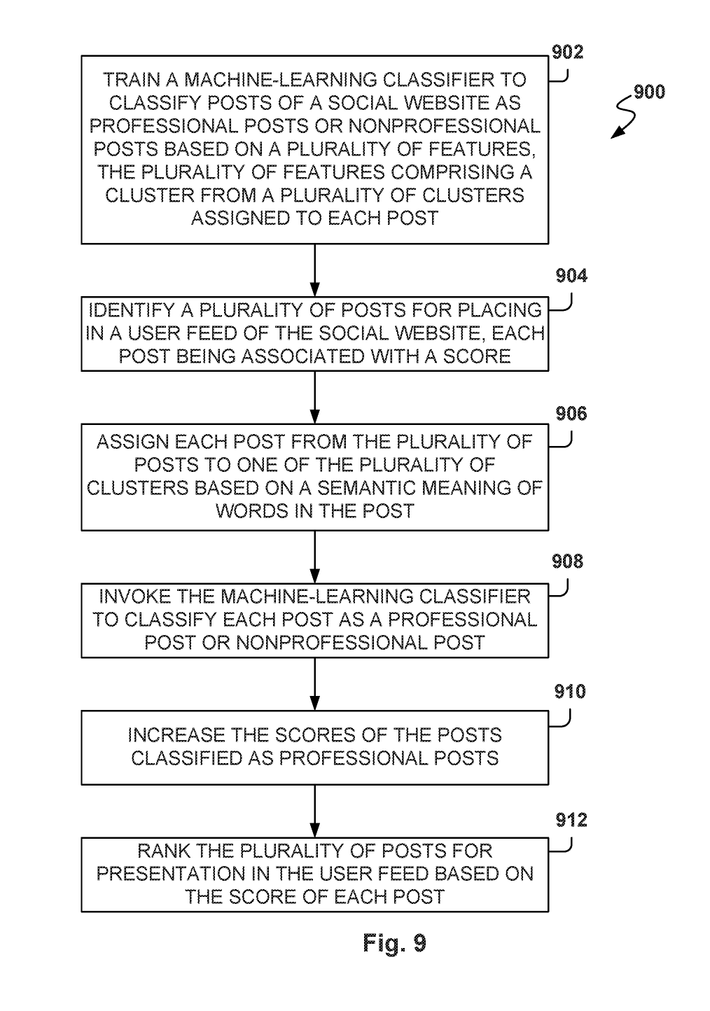

FIG. 9 is a flowchart of a method 900, according to some example embodiments, for optimizing the content of a user feed that includes professional and nonprofessional posts. While the various operations in this flowchart are presented and described sequentially, one of ordinary skill will appreciate that some or all of the operations may be executed in a different order, be combined or omitted, or be executed in parallel.

At operation 902, a machine-learning classifier is trained to classify posts of a social website as professional posts or nonprofessional posts based on a plurality of features. The plurality of features include a cluster from a plurality of clusters assigned to each post. In some example embodiments, the plurality of features include the features 408 described in FIG. 4.

From operation 902, the method flows to operation 904 for identifying a plurality of posts for placing in a user feed of the social website. Each post is associated with a score. At operation 906, each post from the plurality of posts is assigned to one of the plurality of clusters based on a semantic meaning of words in the post.

From operation 906, the method flows to operation 908 for invoking the machine-learning classifier to classify each post as a professional post or nonprofessional post. At operation 910, the scores of the posts classified as professional posts are increased, and at operation 912, the plurality of posts are ranked (e.g., sorted), for presentation in the user feed, based on the score of each post.

In some example embodiments, the assigning of each post further includes calculating a semantic vector for each word in the post; calculating a semantic vector for the post based on the semantic vectors for the words in the post; and k-means clustering the semantic vector of the post to obtain a post cluster identifier that identifies the cluster assigned to the post.

In some example embodiments, the semantic vector is in a multidimensional space, where each semantic vector is positioned in the multidimensional space such that words that share semantic meaning are proximately located in the multidimensional space.

Further, in one example embodiment, the score for each post is based on a click-thorough rate for presentations of the post. In other example embodiments, the professional post is associated with a professional activity of a poster of the post, where the nonprofessional post is not associated with the professional activity of the poster of the post.

Further, in some example embodiments, the training of the machine-learning classifier further includes obtaining a judgment entered by one or more persons for a plurality of training posts; inputting, to a classifier-training program, the plurality of training posts, the judgments for the plurality of training posts, and the plurality of features; and executing the classifier-training program to train the machine-learning classifier.

In one example embodiment, the plurality of features further include one or more of a length of the post; whether the post includes a picture or not; a type of the post selected from a comment, a share, or an original post; a reputation of a poster of the post; and a time of posting. In another example embodiment, the increasing of the scores of the posts classified as professional posts includes multiplying the scores of the posts classified as professional posts by a constant that is greater than 1.

In one example embodiment, the ranking of the plurality of posts further includes sorting the posts in decreasing order of the scores of the posts, where posts with higher scores are presented in the user feed ahead of posts with lower scores. In another example embodiment, the scores for the nonprofessional posts are determined by a machine-learning algorithm based on one or more of features selected from a group including a historical relationship between a viewer and a poster, a connection strength between the viewer and the poster, a type of the post, text in the post, a length of the post, a profile of the poster, and a profile of the viewer.

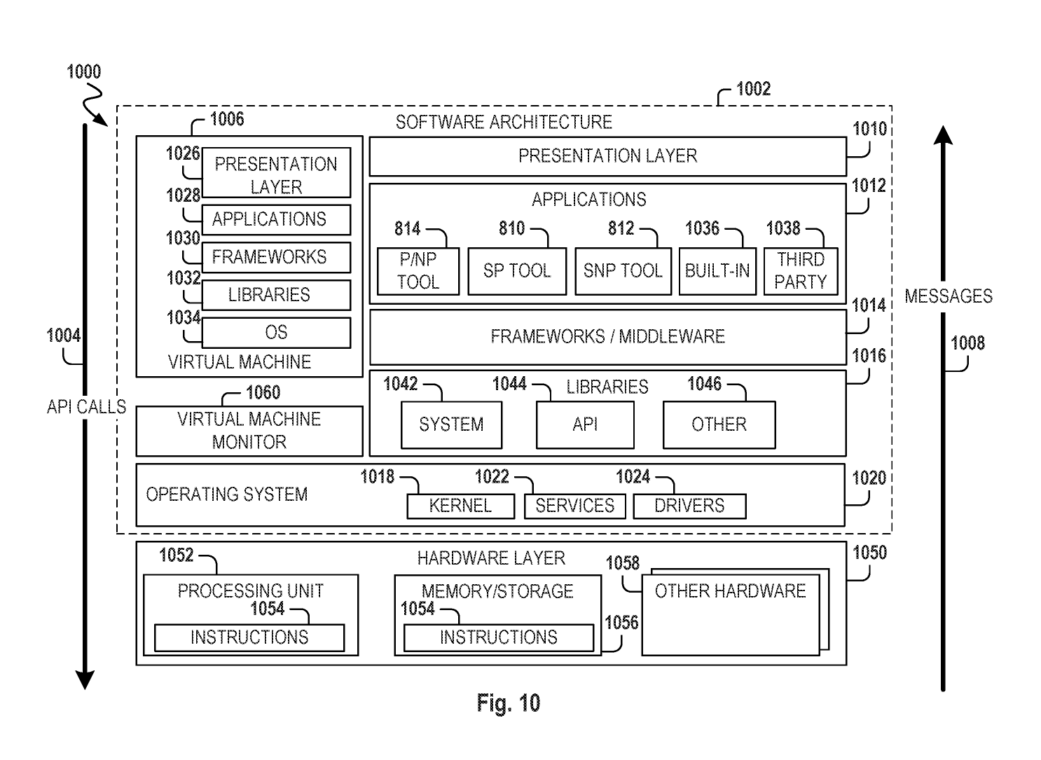

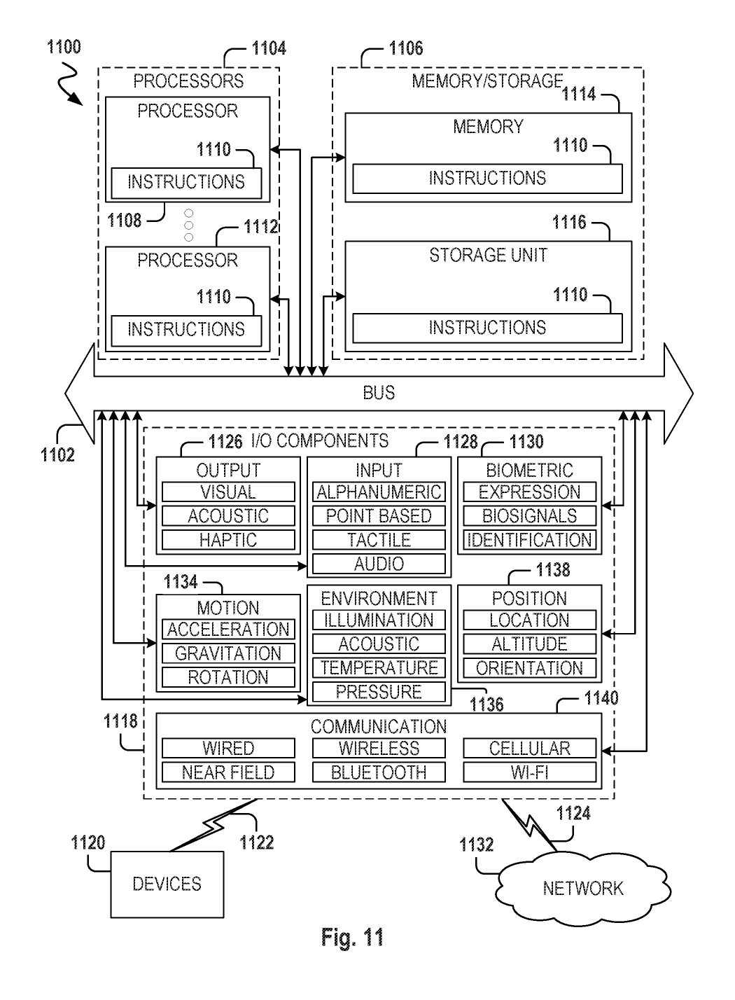

FIG. 10 is a block diagram 1000 illustrating a representative software architecture 1002, which may be used in conjunction with various hardware architectures herein described. FIG. 10 is merely a non-limiting example of a software architecture 1002 and it will be appreciated that many other architectures may be implemented to facilitate the functionality described herein. The software architecture 1002 may be executing on hardware such as a machine 1100 of FIG. 11 that includes, among other things, processors 1104, memory/storage 1106, and I/O components 1118. A representative hardware layer 1050 is illustrated and can represent, for example, the machine 1100 of FIG. 11. The representative hardware layer 1050 comprises one or more processing units 1052 having associated executable instructions 1054. The executable instructions 1054 represent the executable instructions of the software architecture 1002, including implementation of the methods, modules, and so forth of FIGS. 1-9. The hardware layer 1050 also includes memory and/or storage modules 1056, which also have the executable instructions 1054. The hardware layer 1050 may also comprise other hardware 1058, which represents any other hardware of the hardware layer 1050, such as the other hardware illustrated as part of the machine 1100.

In the example architecture of FIG. 10, the software architecture 1002 may be conceptualized as a stack of layers where each layer provides particular functionality. For example, the software architecture 1002 may include layers such as an operating system 1020, libraries 1016, frameworks/middleware 1014, applications 1012, and a presentation layer 1010. Operationally, the applications 1012 and/or other components within the layers may invoke application programming interface (API) calls 1004 through the software stack and receive a response, returned values, and so forth illustrated as messages 1008 in response to the API calls 1004. The layers illustrated are representative in nature and not all software architectures have all layers. For example, some mobile or special purpose operating systems may not provide a frameworks/middleware layer 1014, while others may provide such a layer. Other software architectures may include additional or different layers.

The operating system 1020 may manage hardware resources and provide common services. The operating system 1020 may include, for example, a kernel 1018, services 1022, and drivers 1024. The kernel 1018 may act as an abstraction layer between the hardware and the other software layers. For example, the kernel 1018 may be responsible for memory management, processor management (e.g., scheduling), component management, networking, security settings, and so on. The services 1022 may provide other common services for the other software layers. The drivers 1024 may be responsible for controlling or interfacing with the underlying hardware. For instance, the drivers 1024 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1012 and/or other components and/or layers. The libraries 1016 typically provide functionality that allows other software modules to perform tasks in an easier fashion than to interface directly with the underlying operating system 1020 functionality (e.g., kernel 1018, services 1022, and/or drivers 1024). The libraries 1016 may include system libraries 1042 (e.g., C standard library) that may provide functions such as memory allocation functions, string manipulation functions, mathematic functions, and the like. In addition, the libraries 1016 may include API libraries 1044 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1046 to provide many other APIs to the applications 1012 and other software components/modules.

The frameworks 1014 (also sometimes referred to as middleware) may provide a higher-level common infrastructure that may be utilized by the applications 1012 and/or other software components/modules. For example, the frameworks 1014 may provide various graphic user interface (GUI) functions, high-level resource management, high-level location services, and so forth. The frameworks 1014 may provide a broad spectrum of other APIs that may be utilized by the applications 1012 and/or other software components/modules, some of which may be specific to a particular operating system or platform.

The applications 1012 include the P/NP tool 814, the SP tool 810, the SNP tool 812, built-in applications 1036, and/or third-party applications 1038. Examples of representative built-in applications 1036 may include, but are not limited to, a contacts application, a browser application, a book reader application, a location application, a media application, a messaging application, and/or a game application. The third-party applications 1038 may include any of the built-in applications 1036 as well as a broad assortment of other applications. In a specific example, the third-party application 1038 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1038 may invoke the API calls 1004 provided by the mobile operating system such as the operating system 1020 to facilitate functionality described herein.

The applications 1012 may utilize built-in operating system functions (e.g., kernel 1018, services 1022, and/or drivers 1024), libraries (e.g., system libraries 1042, API libraries 1044, and other libraries 1046), or frameworks/middleware 1014 to create user interfaces to interact with users of the system. Alternatively, or additionally, in some systems interactions with a user may occur through a presentation layer, such as the presentation layer 1010. In these systems, the application/module “logic” can be separated from the aspects of the application/module that interact with a user.

Some software architectures utilize virtual machines. In the example of FIG. 10, this is illustrated by a virtual machine 1006. A virtual machine creates a software environment where applications/modules can execute as if they were executing on a hardware machine (such as the machine 1100 of FIG. 11, for example). The virtual machine 1006 is hosted by a host operating system (e.g., operating system 1020 in FIG. 10) and typically, although not always, has a virtual machine monitor 1060, which manages the operation of the virtual machine 1006 as well as the interface with the host operating system (e.g., operating system 1020). A software architecture executes within the virtual machine 1006 such as an operating system 1034, libraries 1032, frameworks/middleware 1030, applications 1028, and/or a presentation layer 1026. These layers of software architecture executing within the virtual machine 1006 can be the same as corresponding layers previously described or may be different.

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein may be executed. For example, the instructions 1110 may cause the machine 1100 to execute the flow diagrams of FIGS. 3 and 9. Additionally, or alternatively, the instructions 1110 may implement the machine-learning tools, P/NP tool, SP tool, and SNP tool of FIGS. 8 and 10, and so forth. The instructions 1110 transform the general, non-programmed machine 1100 into a particular machine 1100 programmed to carry out the described and illustrated functions in the manner described.

In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1110, sequentially or otherwise, that specify actions to be taken by the machine 1100. Further, while only a single machine 1100 is illustrated, the term “machine” shall also be taken to include a collection of machines 1100 that individually or jointly execute the instructions 1110 to perform any one or more of the methodologies discussed herein.

The machine 1100 may include processors 1104, memory/storage 1106, and I/O components 1118, which may be configured to communicate with each other such as via a bus 1102. In an example embodiment, the processors 1104 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1108 and a processor 1112 that may execute the instructions 1110. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single core, a single processor with multiple cores (e.g., a multi-core processor), multiple processors with a single core, multiple processors with multiples cores, or any combination thereof.

The memory/storage 1106 may include a memory 1114, such as a main memory, or other memory storage, and a storage unit 1116, both accessible to the processors 1104 such as via the bus 1102. The storage unit 1116 and memory 1114 store the instructions 1110 embodying any one or more of the methodologies or functions described herein. The instructions 1110 may also reside, completely or partially, within the memory 1114, within the storage unit 1116, within at least one of the processors 1104 (e.g., within the processor's cache memory), or any suitable combination thereof, during execution thereof by the machine 1100. Accordingly, the memory 1114, the storage unit 1116, and the memory of the processors 1104 are examples of machine-readable media.

As used herein. “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1110. The term “machine-readable medium” shall also be taken to include any medium, or combination of multiple media, that is capable of storing instructions (e.g., instructions 1110) for execution by a machine (e.g., machine 1100), such that the instructions, when executed by one or more processors of the machine (e.g., processors 1104), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1118 may include a wide variety of components to receive input, provide output, produce output, transmit information, exchange information, capture measurements, and so on. The specific I/O components 1118 that are included in a particular machine will depend on the type of machine. For example, portable machines such as mobile phones will likely include a touch input device or other such input mechanisms, while a headless server machine will likely not include such a touch input device. It will be appreciated that the I/O components 1118 may include many other components that are not shown in FIG. 11. The I/O components 1118 are grouped according to functionality merely for simplifying the following discussion, and the grouping is in no way limiting. In various example embodiments, the I/O components 1118 may include output components 1126 and input components 1128. The output components 1126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1118 may include biometric components 1130, motion components 1134, environmental components 1136, or position components 1138 among a wide array of other components. For example, the biometric components 1130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1134 may include acceleration sensor components (e.g., accelerometer), gravitation sensor components, rotation sensor components (e.g., gyroscope), and so forth. The environmental components 1136 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1138 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1118 may include communication components 1140 operable to couple the machine 1100 to a network 1132 or devices 1120 via a coupling 1124 and a coupling 1122 respectively. For example, the communication components 1140 may include a network interface component or other suitable device to interface with the network 1132. In further examples, the communication components 1140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1120 may be another machine or any of a wide variety of peripheral devices (e.g., a peripheral device coupled via a USB).

Moreover, the communication components 1140 may detect identifiers or include components operable to detect identifiers. For example, the communication components 1140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as location via Internet Protocol (IP) geo-location, location via Wi-Fi® signal triangulation, location via detecting an NFC beacon signal that may indicate a particular location, and so forth.

In various example embodiments, one or more portions of the network 1132 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1132 or a portion of the network 1132 may include a wireless or cellular network and the coupling 1124 may be a Code Division Multiple Access (CDMA) connection, a Global System for Mobile communications (GSM) connection, or another type of cellular or wireless coupling. In this example, the coupling 1124 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1110 may be transmitted or received over the network 1132 using a transmission medium via a network interface device (e.g., a network interface component included in the communication components 1140) and utilizing any one of a number of well-known transfer protocols (e.g., hypertext transfer protocol (HTTP)). Similarly, the instructions 1110 may be transmitted or received using a transmission medium via the coupling 1122 (e.g., a peer-to-peer coupling) to the devices 1120. The term “transmission medium” shall be taken to include any intangible medium that is capable of storing, encoding, or carrying the instructions 1110 for execution by the machine 1100, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
training a machine-learning classifier to classify posts of a social website as professional posts or nonprofessional posts based on a plurality of features, the plurality of features comprising a cluster from a plurality of clusters assigned to each post;
identifying a plurality of posts for placing in a user feed of the social website, each post being associated with a score;
assigning each post from the plurality of posts to one of the plurality of clusters based on a semantic meaning of words in the post;
invoking the machine-learning classifier to classify each post as a professional post or a nonprofessional post;
increasing the scores of the posts classified as professional posts; and
ranking the plurality of posts for presentation in the user feed based on the score of each post, wherein operations of the method are executed by a processor.

2. The method as recited in claim 1, wherein the assigning of each post further comprises:
calculating a semantic vector for each word in the post;
calculating a semantic vector for the post based on the semantic vectors for the words in the post; and
k-means clustering the semantic vector of the post to obtain a post cluster identifier that identifies the cluster assigned to the post.

3. The method as recited in claim 2, wherein the semantic vector is in a multidimensional space, wherein each semantic vector is positioned in the multidimensional space such that words that share semantic meaning are proximately located in the multidimensional space.

4. The method as recited in claim 1, wherein the score for each post is based on a click-thorough rate for presentations of the post.

5. The method as recited in claim 1, wherein the professional post is associated with a professional activity of a poster of the post, wherein the nonprofessional post is not associated with the professional activity of the poster of the post.

6. The method as recited in claim 1, wherein the training of the machine-learning classifier further comprises:
obtaining judgments entered by one or more persons for a plurality of training posts;
inputting, to a classifier-training program, the plurality of training posts, the judgments for the plurality of training posts, and the plurality of features; and
executing the classifier-training program to train the machine-learning classifier.

7. The method as recited in claim 1, wherein the plurality of features further comprise one or more of: a length of the post; whether the post includes a picture or not; a type of the post selected from a comment, a share, or an original post; a reputation of a poster of the post; and a time of posting.

8. The method as recited in claim 1, wherein increasing the scores of the posts classified as professional posts comprises multiplying the scores of the posts classified as professional posts by a constant that is greater than 1.

9. The method as recited in claim 1, wherein ranking the plurality of posts further comprises:
sorting the posts in decreasing order of the scores of the posts, wherein posts with higher scores are presented in the user feed ahead of posts with lower scores.

10. The method as recited in claim 1, wherein the scores for the nonprofessional posts are determined by a machine-learning algorithm based on at least one or more features selected from a group consisting of: a historical relationship between a viewer and a poster, a connection strength between the viewer and the poster, a type of the post, text in the post, a length of the post, a profile of the poster, and a profile of the viewer.

11. A system comprising:
a memory comprising instructions; and
one or more computer processors, wherein the instructions, when executed by the one or more computer processors, cause the one or more computer processors to perform operations comprising:
training a machine-learning classifier to classify posts of a social website as professional posts or nonprofessional posts based on a plurality of features, the plurality of features comprising a cluster from a plurality of clusters assigned to each post;
identifying a plurality of posts for placing in a user feed of the social website, each post being associated with a score;
assigning each post from the plurality of posts to one of the plurality of clusters based on a semantic meaning of words in the post;
invoking the machine-learning classifier to classify each post as a professional post or a nonprofessional post;
increasing the scores of the posts classified as professional posts; and
ranking the plurality of posts for presentation in the user feed based on the score of each post.

12. The system as recited in claim 11, wherein the assigning of each post further comprises:
calculating a semantic vector for each word in the post;
calculating a semantic vector for the post based on the semantic vectors for the words in the post; and
k-means clustering the semantic vector of the post to obtain a post cluster identifier that identifies the cluster assigned to the post.

13. The system as recited in claim 11, wherein the professional post is associated with a professional activity of a poster of the post, wherein the nonprofessional post is not associated with the professional activity of the poster of the post.

14. The system as recited in claim 11, wherein the training the machine-learning classifier further comprises:
obtaining judgments entered by one or more persons for a plurality of training posts;
inputting, to a classifier-training program, the plurality of training posts, the judgments for the plurality of training posts, and the plurality of features; and
executing the classifier-training program to train the machine-learning classifier.

15. The system as recited in claim 11, wherein the plurality of features further comprise one or more of a length of the post; whether the post includes a picture or not; a type of the post selected from a comment, a share, or an original post; a reputation of a poster of the post; and a time of posting.

16. A non-transitory machine-readable storage medium including instructions that, when executed by a machine, cause the machine to perform operations comprising:
training a machine-learning classifier to classify posts of a social website as professional posts or nonprofessional posts based on a plurality of features, the plurality of features comprising a cluster from a plurality of clusters assigned to each post;
identifying a plurality of posts for placing in a user feed of the social website, each post being associated with a score;
assigning each post from the plurality of posts to one of the plurality of clusters based on a semantic meaning of words in the post;
invoking the machine-learning classifier to classify each post as a professional post or a nonprofessional post;
increasing the scores of the posts classified as professional posts; and
ranking the plurality of posts for presentation in the user feed based on the score of each post.

17. The machine-readable storage medium as recited in claim 16, wherein the assigning of each post further comprises:
calculating a semantic vector for each word in the post;
calculating a semantic vector for the post based on the semantic vectors for the words in the post; and
k-means clustering the semantic vector of the post to obtain a post cluster identifier that identifies the cluster assigned to the post.

18. The machine-readable storage medium as recited in claim 16, wherein the training the machine-learning classifier further comprises:
obtaining judgments entered by one or more persons for a plurality of training posts;
inputting, to a classifier-training program, the plurality of training posts, the judgments for the plurality of training posts, and the plurality of features; and
executing the classifier-training program to train the machine-learning classifier.

19. The machine-readable storage medium as recited in claim 16, wherein the plurality of features further comprise one or more of a length of the post; whether the post includes a picture or not; a type of the post selected from a comment, a share, or an original post; a reputation of a poster of the post; and a time of posting.

20. The machine-readable storage medium as recited in claim 16, wherein increasing the scores of the posts classified as professional posts comprises multiplying the scores of the posts classified as professional posts by a constant that is greater than 1.
